(19) United States
(12) Patent Application Publication
(10) Pub. No.: US 2010/0144404 A1
(43) Pub. Date: Jun. 10, 2010

(54) SUPPORT APPARATUS FOR PORTABLE DEVICES

(75) Inventor: Gian Luigi CAVANI, Castelvetro (IT)

Correspondence Address: Pearne & Gordon LLP, 1801 East 9th Street, Suite 1200, Cleveland, OH, 44114-3108, US

(73) Assignee: EVOTEK ENGINEERING S.R.L., 41053 Maranello (Modena) (IT)

(21) Appl. No.: 12/629,494

(22) Filed: Dec. 2, 2009

(30) Foreign Application Priority Data
Dec. 4, 2008 (IT) MO2008A000314

(51) Int. Cl. H04M 1/00

(52) U.S. Cl. 455/575.1

(57) ABSTRACT

A support apparatus for portable devices, comprising: a first lever exhibiting a rest surface of a portable device; a second lever for constraining the portable device housed on the rest surface; the first lever and the second lever being hinged in order to be rotatable between a first reciprocally-neared position thereof in which the device is constrained to the first lever and the second lever and a second reciprocally-distanced position thereof in which the device is released from the first lever and the second lever.

### BACKGROUND OF THE INVENTION

The invention relates to an apparatus for supporting portable devices. In particular, the invention relates to a support apparatus for electronic devices such as, for example, mobile telephones, audio/video players and the like.

As is known, support apparatus are mostly used internally of motor vehicles, for maintaining the user's portable devices within the user's reach without the latter having to hold the device.

Under the conditions in which a driver engaged at the steering wheel has to use the portable device, it is necessary for the device to be kept in a visible and reachable position.

It is also true that these portable devices, such as for example the latest generation of touch-screen mobile telephones, have to be arranged in front of the user in order for him or her to see the screen without being excessively distracted from watching the road.

Support apparatus exhibit a main body, generally constrained to the dashboard of the vehicle, or another support structure within the reach of the user, on which a housing for the mobile device is afforded.

At least a slide is mounted on the main body, which slide is mobile in nearing and distancing to the mobile device housed in the housing, for constraining and releasing the device.

In this way, once housed in the housing, the slide is manually moved up to when it comes into contact with the device. In this situation, a recessed seating of the slide retains a lateral edge of the mobile device, keeping it anchored between the slide and the main body.

In order to extract the device from the apparatus, the slide is moved away from the device such as to distance the recessed seating from the lateral edge. Consequently the device is manually extracted from the housing and removed from the apparatus.

During movement of the slide, the device is contemporaneously retained manually internally of the housing so that it is prevented from falling, by force of gravity, out of the apparatus. Consequently the device insertion and removal operations have to be done using both hands, one to keep the device in the housing and another for moving the slide.

Thus the operation is particularly awkward and impractical if the user already has a hand engaged, for example, in driving the vehicle.

Further, the sliding of the slide causes a progressive damaging of the mechanical parts in movement of the slide and the main body, which rub against one another.

In this context, the technical task of the present invention is to provide a support apparatus for portable devices which obviates the drawbacks in the prior art as described herein above.

In particular, the invention has the objective of providing a support apparatus for portable devices which can constrain/release the device in a way which is simple and easy.

A further aim of the present invention is to provide a support apparatus for portable devices which is constructionally simple, relatively economical, and which is not susceptible to damage by continuous use thereof.

The set technical task and the specified aims are substantially attained by a support apparatus for portable devices, comprising the technical characteristics set out in one or more of the accompanying claims.

### BRIEF DESCRIPTION OF THE DRAWINGS

Further characteristics and advantages of the present invention will better emerge from the following description, given by way of non-limiting example, of a preferred but not exclusive embodiment of a support apparatus for portable devices, as illustrated in the accompanying figures of the drawings, in which:

FIG. 1 is a perspective view of a support apparatus for portable devices of the present invention, in a condition of non-use;

FIGS. 2 to 6 are perspective views of the apparatus of FIG. 1 in working conditions of coupling and uncoupling of the apparatus to and from a portable device; and

FIGS. 3 to 7 are lateral views of the apparatus of FIG. 1, with some parts removed better to illustrate others, in working conditions of coupling and subsequent uncoupling with a portable device.

### DESCRIPTION OF THE PREFERRED EMBODIMENTS

With reference to the figures of the drawings, 1 denotes in its entirety a support apparatus of the present invention.

The support apparatus 1 is advantageously usable for portable devices 2, such as for example mobile telephones, of the type schematically illustrated in figures from 2 to 9. Specifically, though not exclusively, the apparatus is destined for use in vehicles.

It is specified that the figures illustrate a device 2 constituted by a touch-screen mobile telephone having a substantially flat conformation. However, the present invention can be used for any type of portable device having any shape and dimension.

In particular, the apparatus 1 comprises a support element 3 having a substantially flat conformation and destined to be associated to a respective mounting structure, such as for example a dashboard of a motor vehicle.

The support element 3 has a substantially rectangular peripheral development and exhibits a rear surface 3a which is provided with special connecting elements 4 to the mounting structure, which are not described in detail as they are of known type.

An upper surface 3b develops on the opposite side of the rear surface 3a, on which a first lever 5 and a second lever 6 are mounted.

In particular, the support element 3 exhibits, at respective smaller sides thereof, two pivoting points 7 on the upper surface 3a and which are destined to engage with the first lever 5 and the second lever 6.

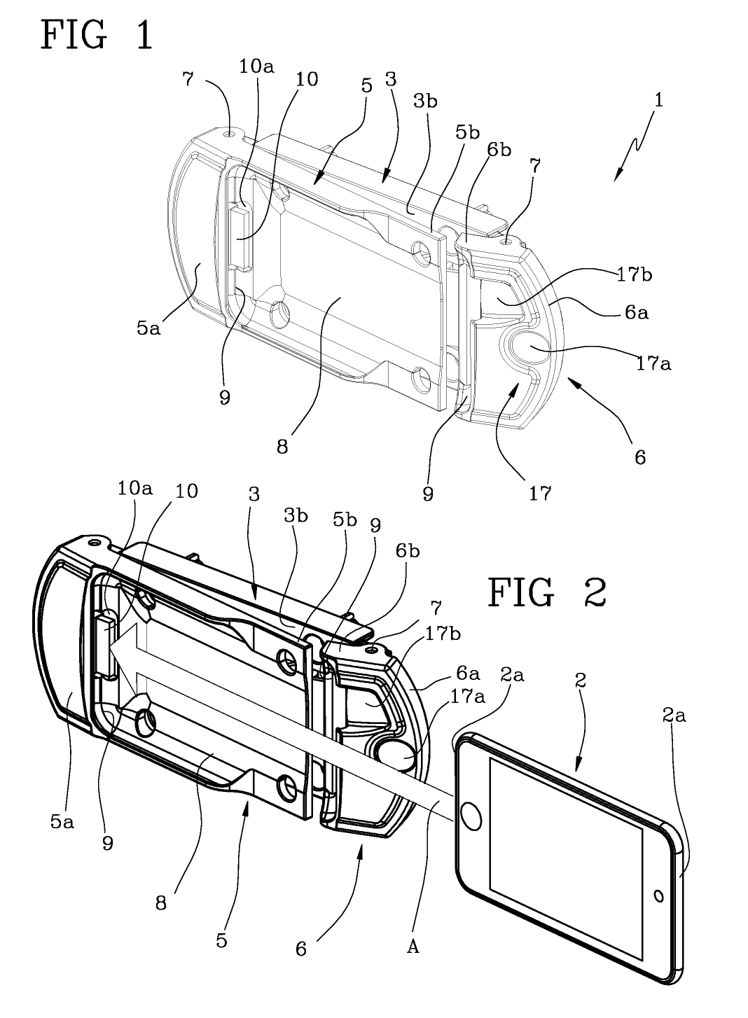

As is more clearly illustrated in FIG. 1, the first lever 5 exhibits a rest surface 8 for housing the portable device 2.

The rest surface 8 is advantageously complementarily shaped to a rear portion of the portable device 2 in order to enable a stable housing of the device 2 in the apparatus 1.

Note that the first lever 5 has a substantially flat conformation and develops above the upper surface 3b of the support element 3.

The first lever 5 is also complementarily shaped with regard to the peripheral configuration of the device 2 and develops over almost the whole of the length of the device 2.

In this situation, as is more clearly visible from the lateral view of FIG. 9, the first lever 5, arranged parallel to the upper surface 3b, covers a predominant portion of the support element. 3.

The first lever 5 exhibits a first end 5a which is rotatably engaged to the support element 3 at a respective pivot point 7, and a second end 5b which is opposite the first end 5a and faces the second lever 6.

The second lever 6 is arranged in front of first lever 5 and is engaged to the support element 3 on the opposite side with respect to the first lever 5. Similarly to the first lever 5, the second lever 6 also exhibits a first end 6a which is rotatably engaged to the support element 3 at a pivot point 7, and a second end 6b opposite the first end 6a which faces the first lever 5.

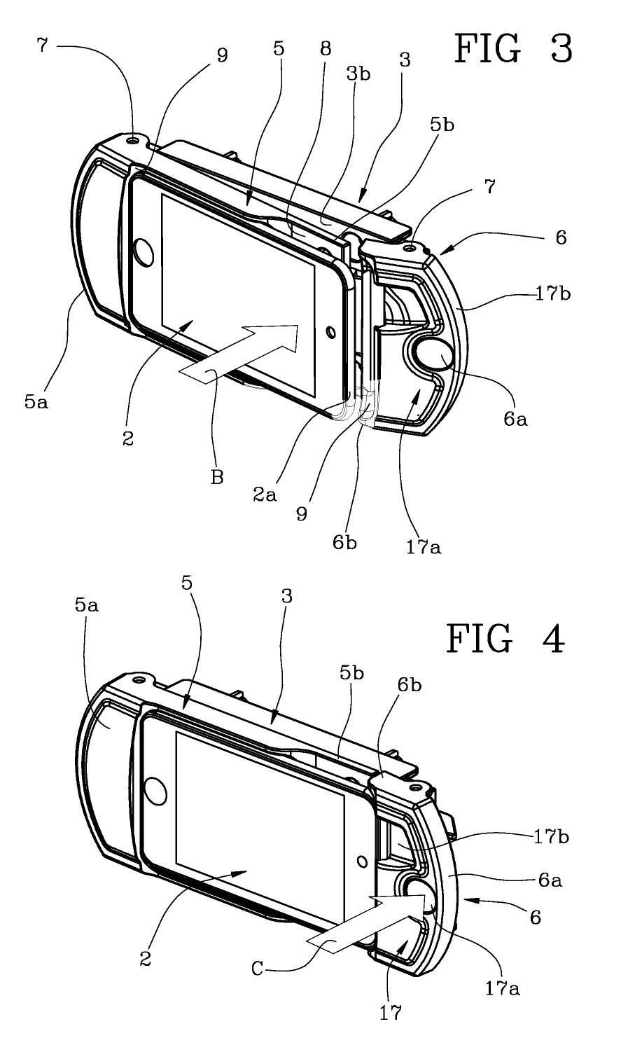

In this situation, the first lever 5 and the second lever 6 are reciprocally hinged to rotate between a first position of reciprocal nearing (FIGS. 4, 8 and 9) in which the device 2 is constrained to the first lever 5 and the second lever 6, and a second reciprocally distanced position (FIGS. 3, 5, 6, 7 and 8) in which the device 2 is released from the first lever 5 and the second lever 6.

Further, the first lever 5 and the second lever 6 are rotatably associated to the support element 3 in order to be rotatable between the first and the second positions about respective parallel axes defined by the pivot points 7.

In this way, the levers 5, 6 in the second reciprocal neared position constitute a housing compartment for the portable device 2.

The housing compartment is laterally defined by lateral cavities 9 afforded internally on the levers 5, 6 and facing one another. Each cavity 9 is destined to contain and constrain respective lateral portions 2a of the portable device 2.

In FIGS. 7, 8 and 9 it can be observed that the device 2 is engaged on the rest surface 8 by firstly inserting a first lateral portion 2a thereof in the cavity 9 of the first lever 5 (FIG. 8) and then inserting a second lateral portion 2a thereof in the cavity 9 of the second lever 6 (FIG. 9).

In the first reciprocally-distanced position (FIGS. 9 and 4) the device 2 is held constrained to the apparatus via the cavities 9 which constrain the lateral portions 2a.

With particular reference to FIGS. 1 and 2, it can be observed that the first lever 5 exhibits an electrical transmission connector 10, housed in an opening 10a afforded on the rest surface 8. The electrical transmission connector 10, not described in detail as it is of known type, is operatively associable to the portable device 2 housed internally of the compartment, and constitutes an interface between the telephone and an electronic control board arranged, for example, internally of the vehicle. The electrical transmission connector 10 can be for example constituted by a battery charger for supplying the device 2 or by a data transmission cable. Insertion of the connector, a particularly delicate operation for apparatus of this type, is done securely both with regard to the connector and the user, who can perform this task without becoming distracted. If the user is driving a vehicle, the maneuver can be performed without the user's taking his or her eyes off the road.

As mentioned above, the first lever 5 and the second lever 6 are reciprocally hinged at respective second ends 5b, 6b thereof.

In greater detail, the first lever 5 exhibits a coupling spring 11, arranged below the rest surface 8 and facing the second lever 6.

As is better illustrated in FIGS. 7, 8 and 9, the coupling spring 11 is constituted by an elastically-deformable body having a first end 12a constrained to the first lever 5 and a second end 12b which is free and facing the second lever 6.

A recessed seating 13 is afforded on the second end 12b of the body 12, which recessed seating 13 has a substantially arched profile facing towards the second lever 6.

Thus an advance-delay order is established between the two levers, achieved via the vertical and axial rigidity. In other words, during functioning, the spring deforms in both horizontal and vertical directions, with the combination of the two rigidities constituting the advance and delay play between the two levers (it eliminates interference of the command lever with the device 2 during the closure stage).

A pusher element 14 develops below the second lever 6, which pusher element 14 is arranged at the second end 6b and is associated to the coupling spring 11.

In particular, the pusher element 14 exhibits a projection 15 that extends from the second end 6b of the second lever 6 and below the rest surface 8. A protuberance 16 projects from the end of the projection 15, which protuberance 16 has a substantially cylindrical profile that is housed in the recessed seating 13 of the spring 11.

The body 12 of the spring 13 is preferably made of an elastic material, in order that it can deform under the thrusting action of the pusher 14.

During the movement of the levers 5, 6 towards one another, the pusher 14 acts on the spring 11 and compresses it until it is stable in the first position. The second lever 6 further exhibits a larger activating surface 17, compressible by an operator, to enable rotation of the second lever 6, and consequently the first lever 5 too, returning the apparatus into the first position in which the device is not constrained to the levers 5, 6.

As is better illustrated in figures from 1 to 6, the upper surface 17 is arranged externally and is visible; it exhibits a pressure point 17a which can be pressed by the user and a recess 17b for enabling a lateral portion 2a of the device 2 to be gripped and thereafter removed.

In use, starting from the conditions of FIGS. 1 and 7 in which the levers 5, 6 are in the respective second position of reciprocal distancing, the device 2 is inserted and slid on the rest surface of the first lever 5.

In greater detail, as indicated by arrow A in FIGS. 2 and 7, the device 2 is inserted from the second end 5b of the first lever 5 up to when the device 2 is totally supported on the first lever 5.

At this point, as illustrated in FIGS. 3 and 8, the device 2 is pressed down on the first lever 5 and acts directly thereon, as indicated by arrow B. Consequently, the first lever 5 is moved towards the support element 3 and rotated about the respective point 7. The connecting mechanism defined by the spring 11 and the pusher 14 thus imposes a movement on the second lever 6 too.

In this way the two levers 5, 6 are reciprocally neared and move into the position illustrated in FIGS. 4 and 9.

During this movement, the pusher 14 acts on the spring 11 to compress it and cause deformation thereof. The cylindrical shape of the protuberance 16 enables rotation of the protuberance internally of the recessed seating 13.

By virtue of the elastic deformation of the spring 11, the levers 5, 6 remain stably in the respective neared position, hooking the lateral portions 2a of the device 2 in the cavities 9 of the levers 5 and 6.

To extract the device 2 from the apparatus 1, the user uses his or her finger to compress the pressure point 17a afforded on the second lever 6, as indicated by arrow C.

At this point, the second lever 6 is forced to rotate away from the support element 3, which draws the first lever 5 into rotation.

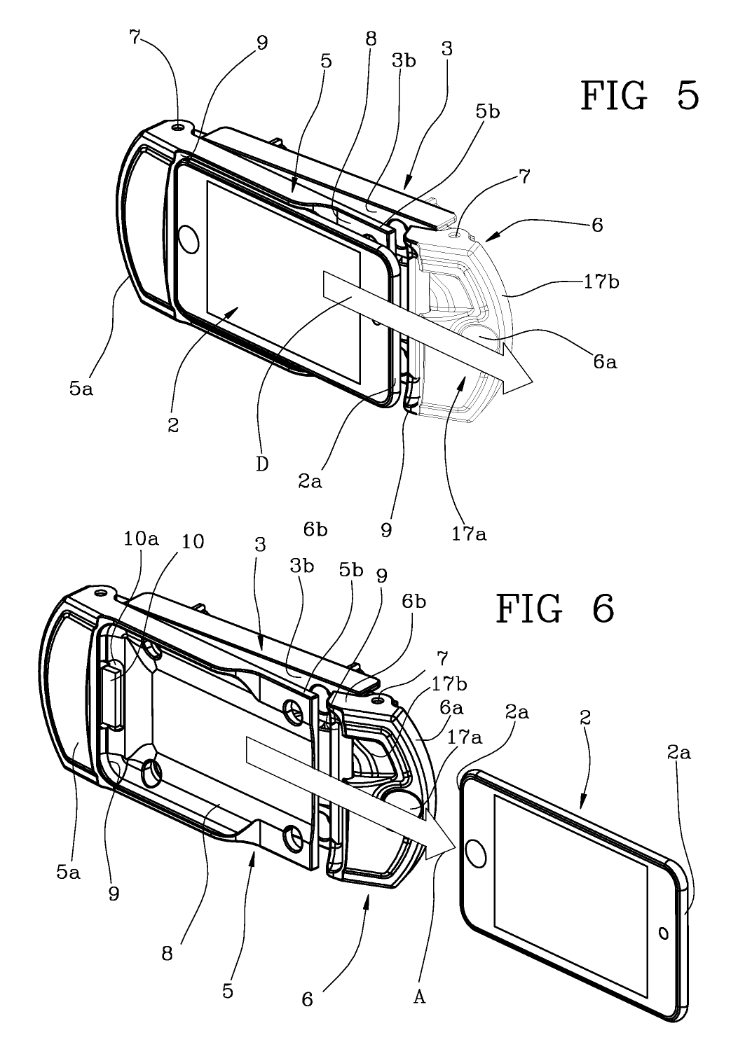

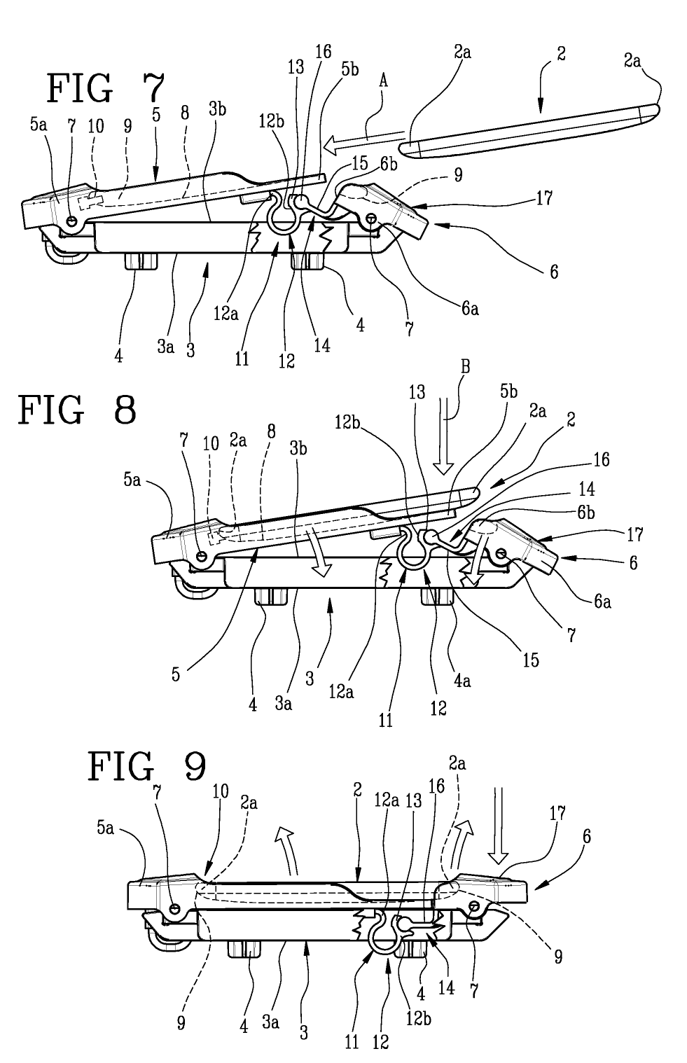

Consequently the levers 5, 6 are returned into the second reciprocally distanced position (FIGS. 5 and 6). At this point, the operator can unslide the device 2 from the rest surface 8 and remove it along the direction of arrow D.

The apparatus thus enables coupling and decoupling the device 2 simply and easily. The movement of the levers 5, 6 which engage the device 2 can be done with a single hand.

Once the device 2 is inserted on the rest surface 8, the engaged condition is effected directly on the device 2, pushing it towards the support element 3. Similarly, in order to extract the device 2 from the apparatus 1, simple pressure is applied on the second lever 6.

The apparatus 1 also exhibits a constructionally simple structure, which is not unwieldy and is relatively inexpensive. Also worthy of note is the absence of dragging mechanical parts (the two levers 5, 6 both rotate and do not slide on one another); this saves the apparatus 1 from rapid wear and damage.

What is claimed:

1. A support apparatus for portable devices, comprising:
a first lever exhibiting a rest surface of a portable device;
a second lever for constraining the portable device housed on the rest surface;
the first lever and the second lever being hinged in order to be rotatable between a first reciprocally-neared position thereof in which the device is constrained to the first lever and the second lever and a second reciprocally-distanced position thereof in which the device is released from the first lever and the second lever.

2. The apparatus of the preceding claim, wherein the first lever and the second lever in the reciprocally-neared second position define a housing for the portable device; the housing being complementarily shaped with respect to a posterior portion of the portable device.

3. The apparatus of the preceding claim, wherein the first lever and the second lever respectively comprise reciprocally-facing lateral cavities for fitting lateral portions of the portable device in the second position of the first lever and the second lever.

4. The apparatus of claim 1, wherein it further comprises a support element, the first lever and the second lever being rotatably associated to the support element in order to be rotatable between the first position and the second position about respective parallel axes.

5. The apparatus of the preceding claim, wherein the first lever comprises: a first end which is rotatably engaged to the support element; a second end opposite the first end and facing the second lever; and a coupling spring, arranged below the rest surface and at the second end.

6. The apparatus of the preceding claim, wherein the coupling spring comprises: an elastically-deformable body exhibiting a first end which is constrained to the first lever, and a second end which is free and facing the second lever; and a recessed seating afforded in the second end of the body and exhibiting a substantially arched profile.

7. The apparatus of claim 5, wherein the second lever comprises: a first end rotatably engaged to the support element; a second end opposite the first end and facing the first lever; and a pusher element, arranged at the second end and associated to the coupling spring.

8. The apparatus of the preceding claim, wherein the pusher element comprises a projection which extends from the second end of the second lever to below the rest surface, and which exhibits a cylindrical protuberance housed in the recessed seating of the spring.

9. The apparatus of the preceding claim, wherein the body of the spring is deformable by the thrusting action of the pusher during the movement of the first lever and the second lever between the first position and the second position.

10. The apparatus of claim 1, wherein the second lever further comprises an upper activating surface, compressible by a user, for rotating the second lever to return the said second lever into the first position in which the device is not constrained to the first lever and the second lever.

11. The apparatus of claim 2, wherein it further comprises an electrical transmission connector, housed in an opening afforded on the rest surface of the first lever and operatively associable to the portable device housed in the chamber.
